(19) United States
(12) Patent Application Publication
(10) Pub. No.: US 2013/0175482 A1
(43) Pub. Date: Jul. 11, 2013

(54) MATERIALS, AND THE PRODUCTION AND USE THEREOF

(71) Applicants: Martin SCHULZ-DOBRICK, Mannheim (DE); Aleksei Volkov, Ludwigshafen (DE); Simon Schroedle, Ludwigshafen (DE); Jordan Keith Lampert, Ludwigshafen (DE)

(72) Inventors: Martin SCHULZ-DOBRICK, Mannheim (DE); Aleksei Volkov, Ludwigshafen (DE); Simon Schroedle, Ludwigshafen (DE); Jordan Keith Lampert, Ludwigshafen (DE)

(21) Appl. No.: 13/732,531

(22) Filed: Jan. 2, 2013

Related U.S. Application Data
(60) Provisional application No. 61/583,623, filed on Jan. 6, 2012.

(51) Int. Cl. H01M 4/131

(52) U.S. Cl. CPC H01M 4/131
USPC 252/506; 252/182.1

(57) ABSTRACT

A material of the general formula (I)

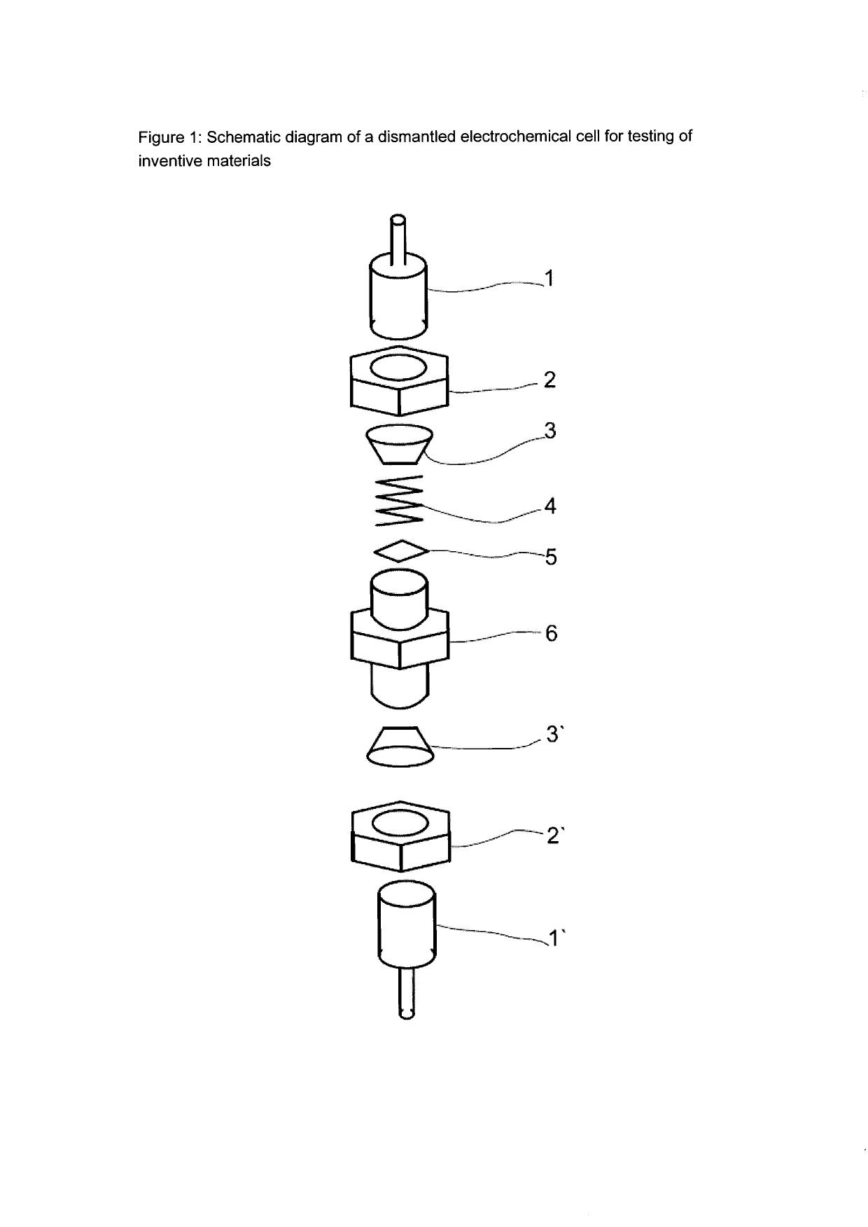

LiₓNiₐCo_{b}Mn_{c}O_{z} (I)

in which the variables are each defined as follows:

0.2≦a≦0.5,

0.0≦b≦0.4,

0.4≦c≦0.65,

1.1≦x≦1.3,

x+a+b+c−0.2≦z≦x+a+b+c+0.2 and

a+b+c=1

where c/a≧1.2, and
where the material has a BET surface area of at least 3 m²/g, and production of the inventive materials and use thereof.

The present invention relates to materials of the general formula (I)

LiₓNiₐCo_{b}Mn_{c}O_{z} (I)

in which the variables are each defined as follows:

0.2≦a≦0.5

0.0≦b≦0.4

0.4≦c≦0.65

1.2≦x≦1.13

x+a+b+c−0.2≦z≦x+a+b+c+0.2 and

a+b+c=1

where c/a≧1.2, and
where the material has a BET surface area of at least 3 m²/g.

The present invention further relates to a process for producing inventive materials and to the use thereof as or in electrode materials.

The present invention further relates to electrodes which comprise at least one inventive electrode material. The present invention further relates to electrochemical cells which comprise at least one inventive electrode.

Electrochemical cells which have a high storage capacity coupled with maximum operating potential are of increasing significance. The desired capacities generally cannot be achieved with electrochemical cells which work on the basis of aqueous systems.

In lithium ion batteries, charge transfer is ensured not by protons in more or less hydrated form, but rather by lithium ions in a nonaqueous solvent or in a nonaqueous solvent system. A particular role is assumed by the electrode material.

Many electrode materials known from the literature are mixed oxides of lithium and one or more transition metals; see, for example, US 2003/0087154. In the charged state of the battery, such materials tend to decompose and to react with the electrolyte system, such that the maximum charging potential is limited in many cases. This limit has an adverse effect on the achievable energy density of the battery. A high energy density of the battery is generally advantageous, especially for mobile applications.

Particular importance is ascribed at present to the lithiated nickel-cobalt-manganese oxides, NCM compounds for short. A distinction is drawn between standard NCM compounds and high-energy NCM compounds.

What are called standard NCM compounds may have discharge capacities of up to 170 mAh/g at an average discharge potential in the region of 3.8 V when they are cycled against elemental lithium between 3.0 V and 4.3 V. Cycling is inadvisable at higher potentials in the case of standard NCM compounds since they age significantly as a result. Most standard NCM compounds described to date are oxidic compounds which feature a molar ratio of lithium to transition metals of about 1.00 to 1.15 and a manganese content of about 15 mol % to 45 mol %, based on the sum of the transition metals (Ni, Co and Mn).

In contrast to these are the high-energy NCM compounds which have discharge capacities of up to 300 mAh/g when they are cycled against elemental lithium between 2.0 V and 4.6 V. The advantage of the high-energy NCM compounds over the standard NCM compounds is that high-energy NCM compounds have a higher energy density and are more stable when they are cycled up to 4.6 V. A disadvantage, however, is that the average discharge potential is below 3.5 V and falls by 0.1 V to 0.4 V when high-energy NCM compounds are cycled.

A technical problem can arise in the case of use of cathode materials in batteries when the potential range in which the capacity is released is very low and/or changes from cycle to cycle, more particularly when it falls. This fall in potential is undesirable since the energy density falls as a result and determination of the charge state of the battery by measuring the potential is made more difficult.

It was thus an object of the present invention to provide materials with which electrochemical cells with high discharge capacity can be produced when they are cycled against elemental lithium between 2.0 V and 4.6 V, the materials exhibiting only a very small fall in potential, if any, in the course of cycling.

It was a further object of the present invention to provide a process for producing materials which have the above-described properties. It was a further object of the present invention to provide uses for materials which have the above-described properties.

In the context of the present inventions, cycling refers to the charging and discharging again of batteries or of electrochemical cells.

Accordingly, the materials defined at the outset of the general formula (I) having a BET surface area of at least 3 m²/g have been found, where the variables in

LiₓNiₐCo_{b}Mn_{c}O_{z} (I)

are defined as follows:

0.2≦a≦0.5, preferably 0.25≦a≦0.45,

0.0≦b≦0.4, preferably 0.00≦b≦0.30,

0.4≦c≦0.65, preferably 0.4≦c≦0.6,

1.1≦x≦1.3, preferably 1.12≦x≦1.26,

x+a+b+c−0.2≦z≦x+a+b+c+0.2

a+b+c=1

where c/a≧1.2, and
where the material has a BET surface area of at least 3 m²/g.

The BET surface area can be determined, for example, by nitrogen adsorption, for example to DIN ISO 9277:2003-05.

In one embodiment of the present invention, inventive materials have a BET surface area of not more than 15 m²/g.

In one embodiment of the present invention, inventive materials have essentially layer structure, i.e. are layer oxides. The structure of the respective crystal lattice can be determined by methods known per se, for example x-ray diffraction or electron diffraction, especially by x-ray powder diffractometry.

In one embodiment of the present invention, the inventive materials may be doped with a total of up to 2% by weight of metal ions, selected from cations of Na, K, Rb, Cs, alkaline earth metal, Ti, V, Cr, Fe, Cu, Ag, Zn, B, Al, Zr, Mo, W, Nb, Si, Ga and Ge, preferably with up to one % by weight. In another embodiment of the present invention, inventive materials are undoped.

In this context, “doping” shall be understood to mean that, in the course of production of inventive materials, in one or more steps, at least one compound having one or more cations selected from cations of Na, K, Rb, Cs, alkaline earth metal, Ti, V, Cr, Fe, Cu, Ag, Zn, B, Al, Zr, Mo, W, Nb, Si, Ga and Ge is added. Impurities introduced through slight impurities in the starting materials, for example in the range from 0.1 to 100 ppm of Na ions, based on the inventive material, shall not be referred to as doping in the context of the present invention.

In one embodiment of the present invention, inventive material has up to a maximum of 1% by weight of sulfate or carbonate. In another embodiment of the present invention, inventive material does not have any detectable proportions of sulfate and/or carbonate.

In one embodiment of the present invention, compound of the general formula (I) is in the form of an amorphous powder. In another embodiment of the present invention, compound of the general formula (I) is in the form of crystalline powder.

In one embodiment of the present invention, inventive material is in the form of particles having a mean diameter (number average) in the range from 10 nm to 200 μm, preferably 20 nm to 30 μm, measured by evaluation of electron micrographs.

In one embodiment of the present invention, inventive material is in the form of essentially spherical secondary agglomerates of primary particles. The particle diameter (D50) of the secondary agglomerates of inventive material may be in the range from 2 to 50 μm, preferably in the range from 2 to 25 μm, more preferably in the range from 4 to 20 μm. Particle diameter (D50) in the context of the present invention refers to the mean particle diameter (weight average), as determinable, for example, by light scattering.

With the aid of compound of the general formula (I), it is possible to produce electro-chemical cells with good properties. More particularly, it is observed that electrochemical cells produced with compound of general formula (I) have a high discharge capacity when they are cycled against elemental lithium between 2.0 V and 4.6 V, and the electrochemical cells in question exhibit only a very small fall in potential, if any, in the course of cycling. The mean discharge potential is generally, in the case of cycling between 2.0 V and 4.6 V against elemental lithium and at current rates of 25 mA/g, greater than 3.6 V.

The present invention further provides electrodes comprising inventive material.

Inventive material can also be referred to in the context of the present invention as material (A).

In one embodiment of the present invention, compound of the general formula (I) is used in inventive electrodes as a composite with electrically conductive, carbonaceous material. For example, compound of the general formula (I) may be treated, for example coated, with electrically conductive, carbonaceous material. Such composites likewise form part of the subject matter of the present invention.

Electrically conductive, carbonaceous material can be selected, for example, from graphite, carbon black, carbon nanotubes, graphene or mixtures of at least two of the aforementioned substances. In the context of the present invention, electrically conductive, carbonaceous material can also be referred to as carbon (B) for short.

In one embodiment of the present invention, electrically conductive, carbonaceous material is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, electrically conductive, carbonaceous material is partially oxidized carbon black.

In one embodiment of the present invention, electrically conductive, carbonaceous material comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie lngenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be prepared by processes known per se. For example, a volatile carbon compound, for example methane or carbon monoxide, acetylene or ethylene, or a mixture of volatile carbon compounds, for example synthesis gas, can be decomposed in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon-containing compounds in a light arc, specifically in the presence or absence of a decomposition catalyst.

In one embodiment, the decomposition of volatile carbon-containing compound or carbon-containing compounds is performed in the presence of a decomposition catalyst, for example Fe, Co or preferably Ni.

In the context of the present invention, graphene is understood to mean almost ideally or ideally two-dimensional hexagonal carbon crystals with a structure analogous to single graphite layers.

In one embodiment of the present invention, in inventive electrodes the weight ratio of compound of the general formula (I) to electrically conductive, carbonaceous material is in the range from 200:1 to 5:1, preferably 100:1 to 10:1.

A further aspect of the present invention is an electrode, especially a cathode, comprising at least one compound of the general formula (I), at least one electrically conductive, carbonaceous material and at least one binder. Compound of the general formula (I), at least one electrically conductive, carbonaceous material and at least one binder are combined to form electrode material which likewise forms part of the subject matter of the present invention.

Compound of the general formula (I) and electrically conductive, carbonaceous material have been described above.

Suitable binders are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment, in inventive electrodes, electrically conductive, carbonaceous material is selected, for example, from graphite, carbon black, carbon nanotubes, graphene or mixtures of at least two of the aforementioned substances.

In one embodiment of the present invention, inventive electrode material comprises:
(A) in the range from 60 to 98% by weight, preferably 70 to 96% by weight, of compound of the general formula (I),
(B) in the range from 1 to 25% by weight, preferably 2 to 20% by weight, of electrically conductive, carbonaceous material,
   (C) in the range from 1 to 20% by weight, preferably 2 to 15% by weight, of binder.

The geometry of inventive electrodes can be selected within wide limits. It is preferred to configure inventive electrodes in thin layers, for example with a thickness in the range from 10 μm to 250 μm, preferably 20 to 130 μm.

In one embodiment of the present invention, inventive electrodes comprise a foil, for example a metal foil, especially an aluminum foil, or a polymer film, for example a polyester film, which may be untreated or siliconized.

The present invention further provides for the use of inventive electrode materials or inventive electrodes in electrochemical cells. The present invention further provides a process for producing electrochemical cells using inventive electrode material or inventive electrodes. The present invention further provides electrochemical cells comprising at least one inventive electrode material or at least one inventive electrode.

By definition, inventive electrodes in inventive electrochemical cells serve as cathodes. Inventive electrochemical cells comprise a counter-electrode, which is defined as the anode in the context of the present invention, and which may, for example, be a carbon anode, especially a graphite anode, a lithium anode, a silicon anode or a lithium titanate anode.

Inventive electrochemical cells may, for example, be batteries or accumulators.

Inventive electrochemical cells may comprise, in addition to the anode and inventive electrode, further constituents, for example conductive salt, nonaqueous solvent, separator, output conductor, for example made from a metal or an alloy, and also cable connections and housing.

In one embodiment of the present invention, inventive electrical cells comprise at least one nonaqueous solvent which may be liquid or solid at room temperature, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (II) and (III)

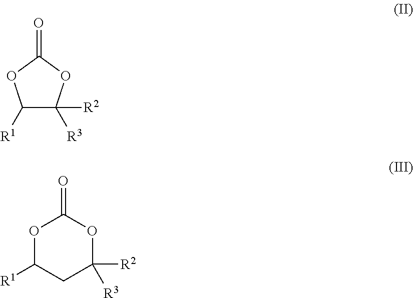

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

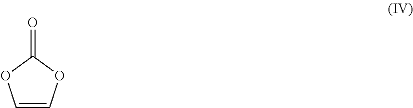

The solvent(s) is (are) preferably used in what is known as the anhydrous state, i.e. with a water content in the range from 1 ppm to 0.1% by weight, determinable, for example, by Karl Fischer titration.

Inventive electrochemical cells further comprise one or more conductive salts. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive electrochemical cells comprise one or more separators by which the electrodes are mechanically separated. Suitable separators are polymer films, especially porous polymer films, which are unreactive toward metallic lithium. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, separators may be selected from PET nonwovens filled with inorganic particles. Such separators may have a porosity in the range from 40 to 55%. Suitable pore diameters are, for example, in the range from 80 to 750 nm.

In another embodiment of the present invention, separators made from fiberglass paper are selected.

Inventive electrochemical cells further comprise a housing which may have any desired shape, for example cuboidal or the shape of a cylindrical disk. In one variant, the housing used is a metal foil elaborated as a pouch.

Inventive electrochemical cells give a high potential and are notable for a high energy density and good stability. More particularly, it is observed that inventive electrochemical cells have a high discharge capacity when they are cycled against elemental lithium between 2.0 V and 4.6 V, the inventive electrochemical cells exhibiting only a very small decline in potential, if any, in the course of cycling. The mean discharge potential in the course of cycling between 2.0 V and 4.6 V against elemental lithium and current rates of 25 mA/g should be greater than 3.6 V.

Inventive electrochemical cells can be combined with one another, for example in series connection or in parallel connection. Series connection is preferred.

The present invention further provides for the use of inventive electrochemical cells in units, especially in mobile units. Examples of mobile units are motor vehicles, for example automobiles, bicycles, aircraft, or water vehicles such as boats or ships. Other examples of mobile units are those which are moved manually, for example computers, especially laptops, telephones, or power tools, for example from the building sector, especially drills, battery-powered drills or battery-powered tackers.

The use of inventive electrochemical cells in units gives the advantage of a longer run time before recharging. If it were desired to achieve the same run time with electrochemical cells with lower energy density, a higher weight would have to be accepted for electrochemical cells.

The present invention further provides a process for the production of electrodes, which comprises

(A) mixing at least one compound of the general formula (I)

LiₓNiₐCo_{b}Mn_{c}O_{z} (I)

in which the variables are each defined as follows:

0.2≦a≦0.5

0.0≦b≦0.4

0.4≦c≦0.65

1.1≦x≦1.3

x+a+b+c−0.2≦z≦x+a+b+c+0.2 and

a+b+c=1

where c/a≧1.2, and
where compound of the general formula (I) has a BET surface area of at least 3 m²/g, and

(B) at least one electrically conductive, carbonaceous material and

(C) at least one binder with one another in one or more steps, and optionally applying them to

(D) at least one metal foil or polymer film.

Compound of the general formula (I), electrically conductive, carbonaceous material or carbon (B) and binder (C) have already been defined above.

The mixing can be effected in one or more steps.

In one variant of the process according to the invention, compound of the general formula (I), carbon (B) and binder (C) are mixed in one step, for example in a mill, especially in a ball mill. Subsequently, the mixture thus obtainable is applied in a thin layer to a carrier, for example a metal foil or polymer film (D). Before or on incorporation into an electrochemical cell, the carrier can be removed. In other variants, the carrier is retained.

In another variant of the process according to the invention, compound of the general formula (I), carbon (B) and binder (C) are mixed in a plurality of steps, for example in a mill, especially in a ball mill. For example, it is possible first to mix compound of the general formula (I) and carbon (B) with one another. This is followed by mixing with binder (C). Subsequently, the mixture thus obtainable is applied in a thin layer to a carrier, for example a metal foil or polymer film (D). Before or on incorporation into an electrochemical cell, the carrier can be removed. In other variants, the carrier is not removed.

In one variant of the process according to the invention, compound of the general formula (I), carbon (B) and binder (C) are mixed in water or an organic solvent (e.g. N-methylpyrrolidone or acetone). The suspension thus obtainable is applied in a thin layer to a carrier, for example a metal foil or polymer film (D), and the solvent is then removed by a heat treatment. Before or on incorporation into an electrochemical cell, the carrier can be removed. In other variants, the carrier is not removed.

Thin layers in the context of the present invention may, for example, have a thickness in the range from 2 μm up to 250 μm.

To improve mechanical stability, the electrodes can be treated thermally or preferably mechanically, for example pressed or calendered.

In one embodiment of the present invention, a carbonaceous, conductive layer is obtained by obtaining a mixture comprising at least one compound of the general formula (I) and at least one carbonaceous, thermally decomposable compound, and subjecting this mixture to a thermal decomposition.

In one embodiment of the present invention, a carbonaceous, conductive layer is obtained by virtue of the presence, during the synthesis of the compound of the general formula (I), of at least one carbonaceous, thermally decomposable compound, which decomposes to form a carbonaceous, conductive layer on the compound of the general formula (I).

The process according to the invention is very suitable for production of inventive electrode material and electrodes obtainable therefrom.

The present invention further provides composites comprising at least one compound of the general formula (I)

LiₓNiₐCo_{b}Mn_{c}O_{z} (I)

in which the variables are each defined as follows:

0.2≦a≦b 0.5

0.0≦b≦0.4

0.4≦c≦0.65

1.1≦x≦1.3

x+a+b+c−0.2≦z≦x+a+b+c+0.2 and

a+b+c=1

where c/a≧1.2, and
where compound of the general formula (I) has a BET surface area of at least 3 m²/g, and
at least one electrically conductive, carbonaceous material, also referred to as carbon (B).

In inventive composites, compound of the general formula (I) has been treated, for example coated, with carbon (B).

In one embodiment of the present invention, in inventive composites, compound of the general formula (I) and carbon (B) are present in a weight ratio in the range from 98:1 to 12:5, preferably 48:1 to 7:2.

Inventive composites are particularly suitable for production of inventive electrode material. A process for production thereof is described above and likewise forms part of the subject matter of the present invention.

The present invention further provides a process for producing inventive compounds of the general formula (I), also called inventive synthesis process. The inventive synthesis process can be performed by first producing a precursor comprising the transition metals in the desired ratio and optionally the dopant(s), preferably by precipitation of mixed carbonates which may be basic. In a second step, mixing with a lithium compound, preferably with lithium hydroxide or with Li₂CO₃, is followed by calcining.

In one embodiment of the present invention, calcination is effected at a maximum temperature in the range from 700 to 1000° C., preferably 800 to 950° C.

In one embodiment of the present invention, calcination is effected over a period in the range from 0.5 to 48 hours, preferably 2 to 8 hours, at the maximum temperature.

For calcination, it is possible, for example, to use a muffle furnace, a rotary tube furnace or a pendulum furnace.

The invention is illustrated by working examples.

General remark: Figures in percent are percent by weight, unless stated otherwise.

ρ denotes the density and is reported in g/ml.

Stated amounts of dissolved salts are based on kg of solution.

The proportion by mass of Ni, Co, Mn and Na was determined by means of inductively coupled plasma atomic emission spectroscopy (ICP-AES). The proportion by mass of CO₃²⁻ was determined via treatment with phosphoric acid and measurement of the CO₂ formed by IR spectroscopy. The proportion by mass of SO₄²⁻ was determined by means of ion chromatography.

Only suspension which was obtained after at least six times the residence time TV had elapsed was used for workup or for analytical purposes.

I. Production of Precursors

I.1 General Method for Production of Transition Metal Carbonate Hydroxide Precursors with a Composition of Ni:Co:Mn in a Molar Ratio of a:b:c

The following solutions were made up:

Solution A: By dissolving nickel sulfate, cobalt sulfate and manganese(II) sulfate in a molar ratio of a:b:c, an aqueous solution of transmission metal salts was prepared. The total transition metal concentration of aqueous solution of transition metal salts was 1.650 mol/kg.

Solution B: 1.30 mol/kg of sodium carbonate and 0.09 mol/kg of ammonium hydrogencarbonate were dissolved in water. ρ_{B}=1.15 g/ml

A continuous precipitation apparatus was initially charged with 1.5 l of water in a nitrogen stream (40 l (STP)/h) (l (STP): standard liters), and solution A with a constant pumping rate PR_{A} of 235 g/h and solution B with the constant pumping rate PR_{B} of 295 g/h were pumped in simultaneously at 55° C. while stirring (1500 revolutions per minute). In the course of this, transition metal carbonate hydroxide precursors with a composition of Ni:Co:Mn in a molar ratio of a:b:c precipitated out, and a suspension formed in the precipitation apparatus.

With the aid of an overflow, a sufficient amount of suspension was withdrawn continuously from the apparatus that an approximately constant volume of suspension was established in the precipitation apparatus in the course of operation thereof. In the precipitation apparatus used, volume V was 1.6 liters.

For further workup of the suspension, the precipitated solids were filtered off and washed with water. The solids thus obtainable were dried in a drying cabinet at 105° C. for 16 hours and then sieved through a sieve of mesh size 50 μm.

The following precursors were produced:

TABLE 1
Relative molar composition of the transition metals
in precursors P.1 to P.3 and C-P.4 to C-P.6

Relative molar composition

| No. | c[Ni] | c[Mn] | c[Co] | of the transition metals |
|---|---|---|---|---|
| P.1 | 16.7 | 21.3 | 8.8 | Ni_{0.346}Mn_{0.472}Co_{0.182} |
| P.2 | 15.9 | 21.7 | 8.1 | Ni_{0.337}Mn_{0.492}Co_{0.171} |
| P.3 | 20.0 | 27.8 | 0 | Ni_{0.402}Mn_{0.598} |
| C-P.4 | 16.3 | 30.0 | 0 | Ni_{0.337}Mn_{0.663} |
| C-P.5 | 10.5 | 30.0 | 5.9 | Ni_{0.217}Mn_{0.662}Co_{0.121} |
| C-P.6 | 17.0 | 15.6 | 17.3 | Ni_{0.334}Mn_{0.327}Co_{0.339} |

c is the concentration of the transition metal in question in the precursor in question and is reported in % by weight, based on the overall precursor in question.

I.2 Method for Production of Comparative Precursor C-P.7

Method for production of transition metal hydroxide comparative precursor C-P.7 with a composition of Ni:Co:Mn in a molar ratio of a:b:c

The following solutions were made up:

Solution A: By dissolving nickel sulfate, cobalt sulfate and manganese(II) sulfate in a molar ratio of a:b:c, an aqueous solution of transmission metal salts was prepared. The total transition metal concentration of solution was 1.650 mol/kg.

Solution B: 5.5 mol/kg of sodium hydroxide and 1.5 mol/kg of ammonia were dissolved in water. ρ_{B}=1.2 g/ml

A continuous precipitation apparatus was initially charged with 1.5 l of water in a nitrogen stream (40 l (STP)/h) (l (STP): standard liters), and solution A with a constant pumping rate PR_{A} of 150 g/h and solution B with the constant pumping rate PR_{B} of 80 g/h were pumped in simultaneously at 50° C. while stirring (1000 revolutions per minute). In the course of this, transition metal hydroxide comparative precursor C-P.7 with a composition of Ni:Co:Mn in a molar ratio of a:b:c precipitated out, and a suspension formed in the precipitation apparatus.

With the aid of an overflow, a sufficient amount of suspension was withdrawn continuously from the apparatus that an approximately constant volume of suspension was established in the precipitation apparatus in the course of operation thereof. In the precipitation apparatus used, volume V was 1.6 liters.

For further workup of the suspension, the precipitated solids were filtered off and washed with water. The solids thus obtainable were dried in a drying cabinet at 105° C. for 16 hours and then sieved through a sieve of mesh size 50 μm.

The following comparative precursor C-P.7 was produced:

TABLE 1a
Relative molar composition of the
transition metals in comparative precursor C-P.7

| | | | | Relative molar composition |
|---|---|---|---|---|
| No. | c[Ni] | c[Mn] | c[Co] | of the transition metals |
| C-P.7 | 22.2 | 30.0 | 11.2 | Ni_{0.339}Mn_{0.49}Co_{0.171} |

c is the concentration of the transition metal in question in the precursor in question and is reported in % by weight, based on the overall precursor in question.

II. General Procedure for Production of Mixed Transition Metal Oxides

For production of inventive materials, precursors according to table 1 or table 1 a were mixed with Li₂CO₃ (molar Li:Ni ratio as x:a). The mixture thus obtainable was transferred into an alumina crucible. Calcination was effected in a muffle furnace by heating at a heating rate of 3 K/min and, on attainment of 350° C. and 650° C., inserting hold times of 4 hours in each case, before increasing the temperature further. Calcination was effected over a period of 6 hours at a calcination temperature T, followed by cooling at a cooling rate of 3° C./min. This afforded inventive materials (A.1) to (A.6) according to table 2.

The procedure was analogous in the production of comparative materials.

TABLE 2
Composition of inventive materials (A.1) to (A.6)
and of comparative materials

| | | | | BET |
|---|---|---|---|---|
| | | | | surface |
| | Pre- | T | | area |
| No. | cursor | [° C.] | Composition | [m²/g] |
| (A.1) | P.1 | 835 | Li_{1.12}Ni_{0.346}Mn_{0.472} | 8.3 |
| | | | Co_{0.182}O_{2.12} | |
| (A.2) | P.1 | 880 | Li_{1.12}Ni_{0.346}Mn_{0.472} | 5.7 |
| | | | Co_{0.182}O_{2.12} | |
| (A.3) | P.2 | 835 | Li_{1.17}Ni_{0.337}Mn_{0.492} | 7.0 |
| | | | Co_{0.171}O_{2.17} | |
| (A.4) | P.2 | 880 | Li_{1.17}Ni_{0.337}Mn_{0.492} | 4.9 |
| | | | Co_{0.171}O_{2.17} | |
| (A.5) | P.3 | 835 | Li_{1.20}Ni_{0.402}Mn_{0.598}O_{2.20} | 9.3 |
| (A.6) | P.3 | 850 | Li_{1.20}Ni_{0.402}Mn_{0.598}O_{2.20} | 7.8 |
| C-1 | C-P.4 | 850 | Li_{1.33}Ni_{0.337}Mn_{0.663}O_{2.33} | 9.3 |
| C-2 | C-P.5 | 835 | Li_{1.40}Ni_{0.217}Mn_{0.662} | 7.4 |
| | | | Co_{0.121}O_{2.40} | |
| C-3 | C-P.6 | 835 | Li_{1.10}Ni_{0.334}Mn_{0.327} | 4.9 |
| | | | Co_{0.339}O_{2.10} | |
| C-4 | C-P.6 | 900 | Li_{1.10}Ni_{0.334}Mn_{0.327} | 2.1 |
| | | | Co_{0.339}O_{2.10} | |
| C-5 | C-P.7 | 850 | Li_{1.17}Ni_{0.339}Mn_{0.491} | 0.5 |
| | | | Co_{0.170}O_{2.17} | |

For all inventive materials, it was found by means of x-ray powder diffratometry that they can essentially be described as layer oxides.

### III. General Method for Production of Inventive Electrodes and Inventive Electrochemical Cells

Materials Used:

Electrically conductive, carbonaceous materials:

Carbon (B.1): carbon black, BET surface area of 62 m²/g, commercially available as “Super P Li” from Timcal

Carbon (B.2): graphite, commercially available as “KS 6” from Timcal

Binder (C.1): copolymer of vinylidene fluoride and hexafluoropropene, as a powder, commercially available as Kynar Flex® 2801 from Arkema, Inc.

Figures in % are based on percent by weight, unless explicitly stated otherwise.

General method using the example of inventive material (A.1):

8.4 g of inventive material (A.1), 0.6 g of carbon (B.1), 0.3 g of carbon (B.2) and 0.7 g of binder (C.1) were mixed with addition of 24 g of N-methylpyrrolidone (NMP) to give a paste. An aluminum foil of thickness 30 μm was coated with the above-described paste (active material loading 6 mg/cm²). After drying at 105° C., circular parts of the aluminum foil thus coated (diameter 20 mm) were punched out. The electrodes thus obtainable were used to produce inventive electrochemical cells EC.1.

The electrolyte used was a 1 mol/l solution of LiPF₆ in ethylene carbonate/dimethyl carbonate (1:1 based on parts by mass). The anode consisted of a lithium foil which was separated from the cathode by a separator of glass fiber paper.

This gave inventive electrochemical cells EC.1.

The procedure was analogous with inventive materials (A.2) to (A.6) and with comparative materials C-1 to C-4.

The inventive electrochemical cells were cycled (charging/discharging) between 4.6 V and 2.0 V at 25° C. The charge and discharge currents were fixed at 25 mA/g of cathode material.

TABLE 3
Electrochemical tests on inventive electrochemical cells

| | Specific discharge capacity | | | Specific discharge capacity | | |
|---|---|---|---|---|---|---|
| | [mAh/g] | | | <3.4 V [mAh/g] | | |
| | 2nd | | 19th/2nd | 2nd | | Δ19th/2nd |
| | cycle | 19th cycle | cycle | cycle | 19th cycle | cycle |
| EC. 1 | 211 | 206 | 97.9% | 25 | 34 | 10 |
| EC. 2 | 194 | 191 | 98.3% | 18 | 23 | 5 |
| EC. 3 | 199 | 198 | 99.6% | 27 | 36 | 9 |
| EC. 4 | 201 | 199 | 98.9% | 21 | 29 | 8 |
| EC. 5 | 215 | 216 | 100.6% | 42 | 52 | 10 |
| EC. 6 | 213 | 215 | 100.6% | 43 | 55 | 11 |
| EC (C-1) | 248 | 249 | 100.5% | 87 | 106 | 19 |
| EC (C-2) | 265 | 262 | 98.6% | 112 | 139 | 26 |
| EC (C-3) | 188 | 178 | 94.7% | 16 | 19 | 3 |
| EC (C-4) | 182 | 161 | 88.4% | 9 | 13 | 4 |
| EC (C-5) | 162 | 136 | 84.0% | 9 | 17 | 8 |

ΔDifference

The inventive materials EC.1 to EC.6 each have high specific discharge capacities, expressed by the retention of capacity from the 2nd to 19th cycle. The inventive materials EC.1 to EC.6 each have good retention of capacity of more than 98%.

The overall potential window of an electrochemical cell is generally in the range of 4.6 V-2.0 V. A technical problem in the case of use of cathode materials in batteries can arise when the potential range in which the capacity is released is very low and/or varies from cycle to cycle. This is measured by determining the specific discharge capacity which is used below 3.4 V. In addition, therefore, the extent to which the specific discharge capacity below 3.4 V increases from the 2nd to the 19th cycle was determined.

By comparison with EC (C-1) and EC (C-2), it can be seen that EC (C-1) and EC (C-2) have much more capacity in the unattractive range below 3.4 V and this capacity increases about twice as much compared to EC.1 to EC.6.

EC (C-3) to EC (C-5), due to their low total capacity and more particularly their low retention of total capacity of below 95%, are much less suitable as cathode materials than EC.1 to EC.6.

1. A material of the general formula (I)
LiₓNiₐCo_{b}Mn_{c}O_{z} (I)
in which the variables are each defined as follows:
0.2≦a≦0.5
0.0≦b≦0.4
0.4≦c≦0.65
1.1≦x≦1.3
x+a+b+c−0.2≦z≦x+a+b+c+0.2 and
a+b+c=1
where c/a≧1.2, and
where the material has a BET surface area of at least 3 m²/g.

2. The material according to claim 1, which has a BET surface area of not more than 15 m²/g.

3. The material according to claim 1 or 2, wherein the variables in compound of the general formula (I) are selected as follows:
0.25≦a≦0.45,
0.00≦b≦0.30,
0.4≦c≦0.6 and
1.12≦x≦1.26.

4. The material according to any of claims 1 to 3, which has been doped with a total of up to 2% by weight of metal ions selected from cations of Na, K, Rb, Cs, alkaline earth metal, Ti, V, Cr, Fe, Cu, Ag, Zn, B, Al, Zr, Mo, W, Nb, Si, Ga and Ge.

5. The material according to any of claims 1 to 4, which has essentially a layer structure.

6. The material according to any of claims 1 to 5, which comprises a maximum of 1% by weight of sulfate or carbonate.

7. An electrode comprising at least one material according to any of claims 1 to 6.

8. The electrode according to claim 7, further comprising at least one electrically conductive, carbonaceous material.

9. The electrode according to claim 8, wherein electrically conductive, carbonaceous material is selected from graphite, carbon black, carbon nanotubes, graphene or mixtures of at least two of the aforementioned substances.

10. The use of electrodes according to any of claims 7 to 9 in electrochemical cells.

11. A process for producing electrochemical cells using material according to any of claims 1 to 6 or electrodes according to claims 7 to 9.

12. A process for producing electrodes using electrode material according to any of claims 1 to 6 or electrodes according to claims 7 to 9.

13. An electrochemical cell comprising electrode material according to any of claims 1 to 6 or electrodes according to claims 7 to 9.

14. The use of electrochemical cells according to claim 13 as a power source in mobile units.

15. The use of electrochemical cells according to claim 13 or 14, wherein the mobile unit is an automobile, a bicycle, an aircraft, a computer, a telephone or a power tool.
